(19) United States
(12) Patent Application Publication
(10) Pub. No.: US 2023/0367780 A1
(43) Pub. Date: Nov. 16, 2023

(54) DATA ENRICHMENT USING NAME, LOCATION, AND IMAGE LOOKUP

(71) Applicant: Plaid Inc., San Francisco, CA (US)

(72) Inventors: Leah KARLINS, New York, NY (US); Richard ZHAO, New York, NY (US); Raymond CANO, New York, NY (US); Josh ISENSTEIN, New York, NY (US); Kina ABE, Union City, NJ (US)

(21) Appl. No.: 18/318,377

(22) Filed: May 16, 2023

Related U.S. Application Data
(60) Provisional application No. 63/364,791, filed on May 16, 2022.

(51) Int. Cl. G06F 16/2458; G06F 16/2455; G06F 16/903

(52) U.S. Cl. CPC G06F 16/2468; G06F 16/2455; G06F 16/90344

(57) ABSTRACT

In some implementations, a server may receive, from a user device and at a secure endpoint of an application programming interface, a set of structured data including a plurality of entries. The server may extract, from each entry, a corresponding partial string from a corresponding description string included in the entry, and may determine, for each partial string, a corresponding data structure in a database. The server may generate, for each entry, a standardized name and a location indicator based on the corresponding data structure, and may extract, for each data structure, an image corresponding to the data structure. Accordingly, the server may return, to the user device, a modified set of structured data including, for each entry, the standardized name, the location indicator, and the corresponding image.

### RELATED APPLICATION

This application claims priority to U.S. Provisional Patent Application No. 63/364,791, filed May 16, 2022, which is incorporated herein by reference in its entirety.

### BACKGROUND

Structured data, such as event data and/or transactional data, often includes string entries describing each entry (e.g., each event or each transaction). Generally, the string entries are written in machine-friendly language rather than natural language.

### SUMMARY

Some implementations described herein relate to a system for data enrichment. The system may include one or more memories and one or more processors communicatively coupled to the one or more memories. The one or more processors may be configured to receive, from a user device and at a secure endpoint of an application programming interface (API), a set of structured data including a plurality of entries. The one or more processors may be configured to extract, from each entry, a corresponding partial string from a corresponding description string included in the entry. The one or more processors may be configured to determine, using a fuzzy search for each partial string, a corresponding data structure in a database. The one or more processors may be configured to generate, for each entry, a standardized name and a location indicator based on the corresponding data structure. The one or more processors may be configured to determine, for each entry, a corresponding image using the standardized name and an image database. The one or more processors may be configured to return, to the user device, a modified set of structured data including, for each entry, the standardized name, the location indicator, and the corresponding image.

Some implementations described herein relate to a method of data enrichment. The method may include receiving, from a user device and at a secure endpoint of an API, a set of structured data including a plurality of entries. The method may include extracting, from each entry, a corresponding partial string from a corresponding description string included in the entry. The method may include determining, for each partial string, a corresponding data structure in a database. The method may include generating, for each entry, a standardized name and a location indicator based on the corresponding data structure. The method may include extracting, for each data structure, an image corresponding to the data structure. The method may include returning, to the user device, a modified set of structured data including, for each entry, the standardized name, the location indicator, and the corresponding image.

Some implementations described herein relate to a non-transitory computer-readable medium that stores a set of instructions for data enrichment for a device. The set of instructions, when executed by one or more processors of the device, may cause the device to receive, from a user device and at a secure endpoint of an API, a set of structured data including a plurality of entries. The set of instructions, when executed by one or more processors of the device, may cause the device to extract, from each entry, one or more candidate strings from a corresponding description string included in the entry. The set of instructions, when executed by one or more processors of the device, may cause the device to determine, for each entry, one or more candidate data structures in a database mapping to the one or more candidate strings. The set of instructions, when executed by one or more processors of the device, may cause the device to generate, for each entry, a standardized name and a location indicator based on a selected data structure from the one or more candidate data structures. The set of instructions, when executed by one or more processors of the device, may cause the device to return, to the user device, a modified set of structured data including, for each entry, the standardized name and the location indicator.

### BRIEF DESCRIPTION OF THE DRAWINGS

FIGS. 1A-1E are diagrams of an example implementation relating to data enrichment using name, location, and image lookup.

FIGS. 2A-2B are diagrams of an example visual representation of data enrichment.

FIGS. 3A-3B are diagrams of example images for an example implementation described herein.

FIG. 4 is a diagram of an example implementation relating to training and using a machine learning model for implementations described herein.

FIG. 5 is a diagram of an example environment in which systems and/or methods described herein may be implemented.

FIG. 6 is a diagram of example components of one or more devices of FIG. 5.

FIG. 7 is a flowchart of an example process relating to data enrichment using name, location, and image lookup.

### DETAILED DESCRIPTION

The following detailed description of example implementations refers to the accompanying drawings. The same reference numbers in different drawings may identify the same or similar elements.

Structured data, such as event data and/or transactional data, often includes string entries describing each entry (e.g., each event or each transaction). Generally, the string entries are written in machine-friendly language rather than natural language. However, machine-friendly language is not user-friendly and does not translate well to audio for impaired users. Standardizing the string entries helps but consumes power and processing resources at a user device and is time-consuming. Additionally, standardization is best when using a database of names and/or locations, but this significantly increases memory overhead at the user device.

Some implementations described herein provide for remote data enrichment of a set of structured data, such as event data and/or transactional data. For example, a remote server may leverage larger databases and more accurate rules and/or machine learning models to improve accuracy and reduce memory overhead as compared with data enrichment performed at a user device. Additionally, the remote server helps the user device conserve power and processing resources as well as reduce latency by performing data enrichment faster and more efficiently.

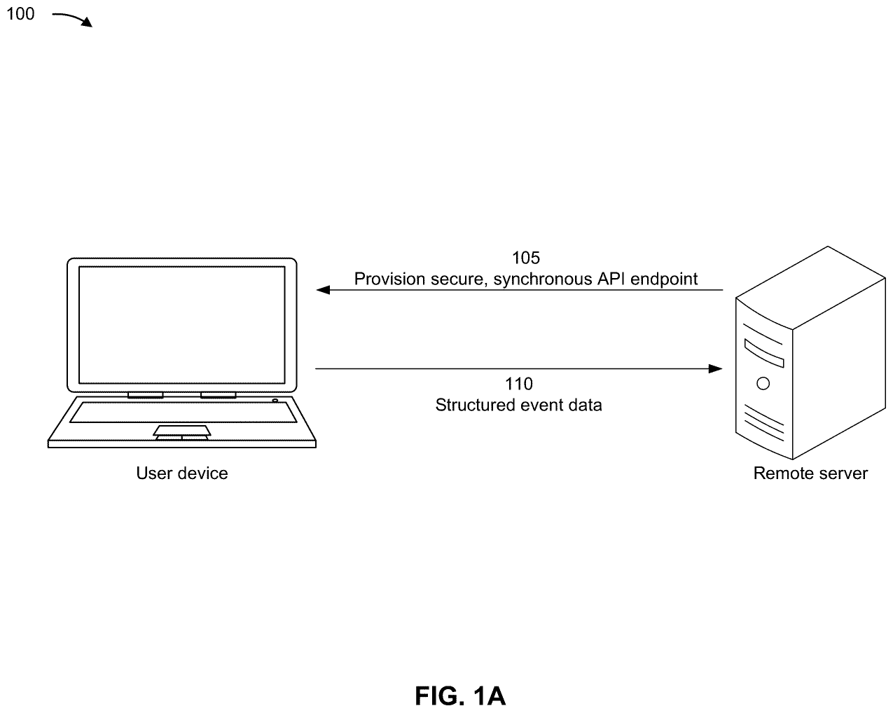

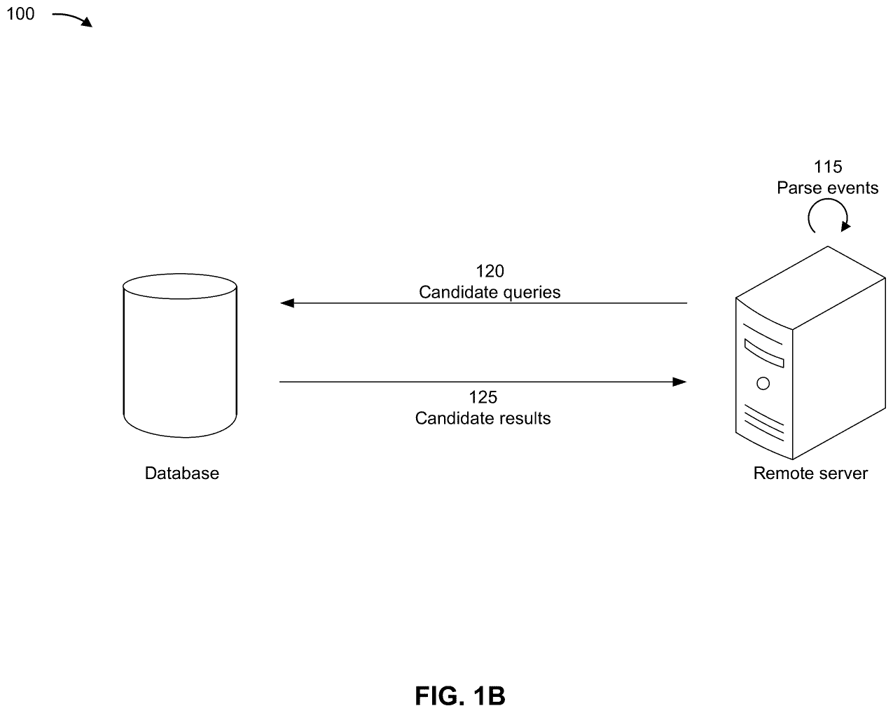

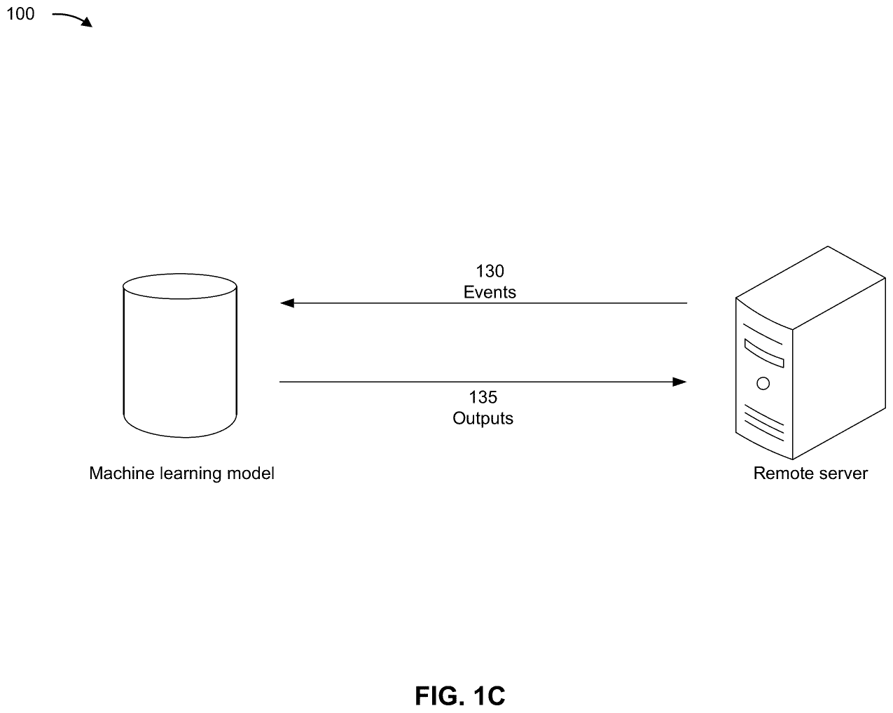

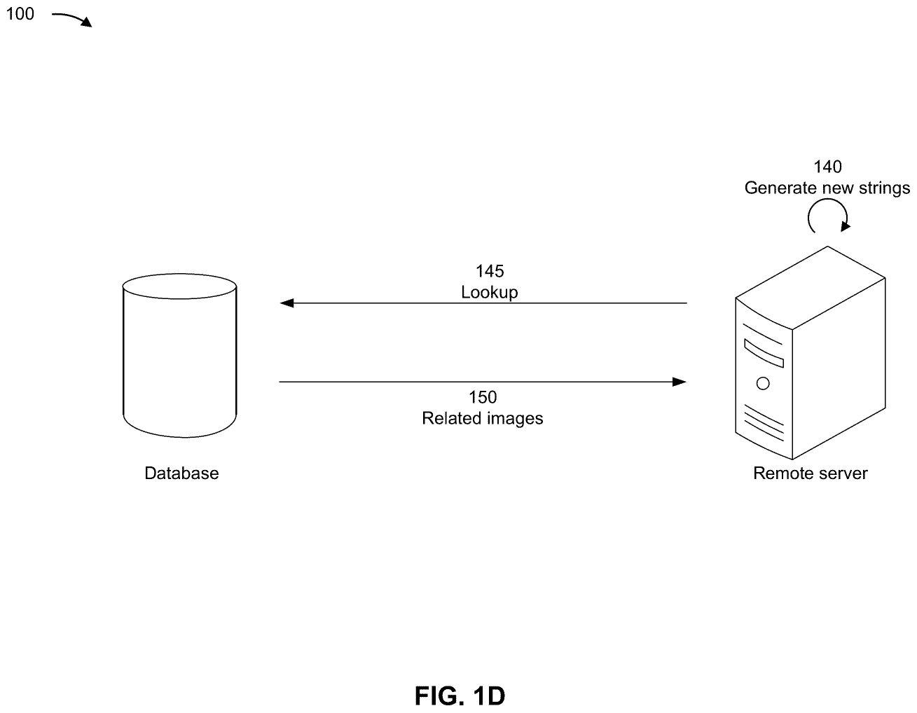

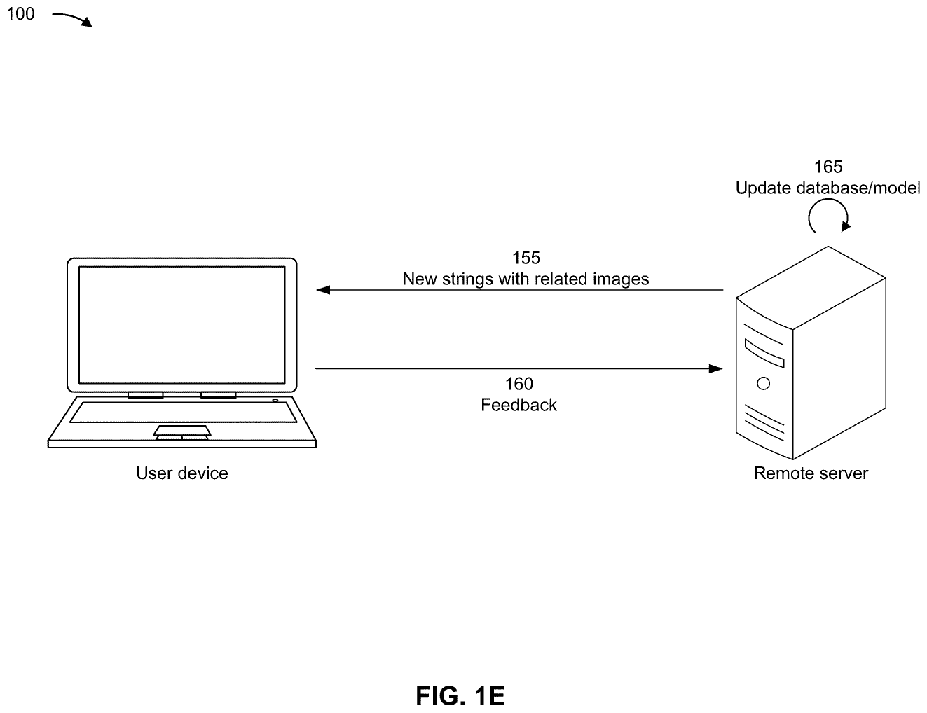

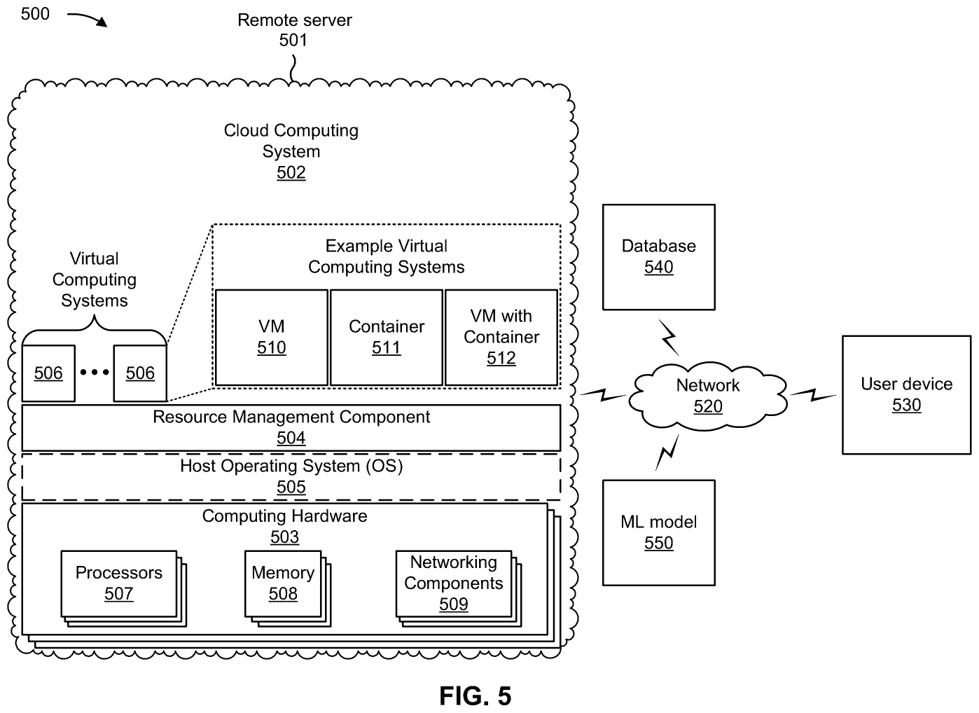

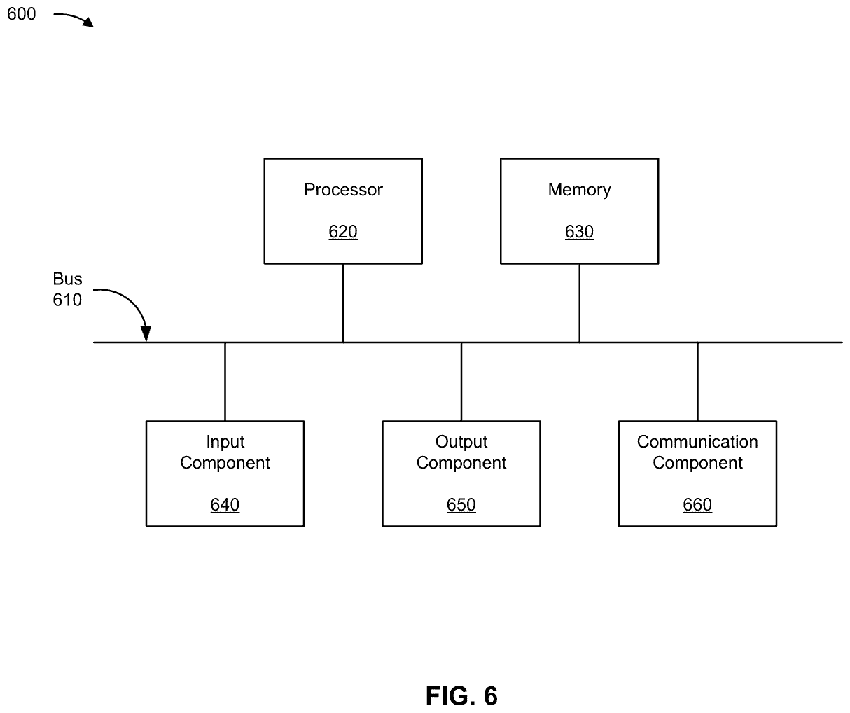

FIGS. 1A-1E are diagrams of an example 100 associated with data enrichment using name, location, and image lookup. As shown in FIGS. 1A-1E, example 100 includes a remote server, a user device, a machine learning model, and a database. These devices are described in more detail in connection with FIGS. 5 and 6.

As shown in FIG. 1A by reference number 105, the remote server may provision a secure, synchronous application programming interface (API) endpoint to the user device. In some implementations, the API may accept a set of structured data for enhancement by the remote server. Although the example 100 is described using an external API (e.g., accessible via the Internet), other examples may include a standalone service (e.g., a Python service) that may be called within a program (e.g., at runtime). Accordingly, the remote server may receive calls from the service rather than directly from the user device.

As shown by reference number 110, the user device may transmit, and the remote server may receive, a set of structured data associated with a set of events (e.g., transactions or another type of events). For example, the user device may call the API and include the set of structured data as a parameter (e.g., as a transactions parameter). Each entry in the set of structured data may include an identifier (e.g., an id parameter assigned by the user device or already included in the set of structured data), a string description (e.g., a description parameter), an amount (e.g., an amount parameter), and/or a currency code (e.g., an iso_currency_code using abbreviations from the International Standards Organization (ISO)), among other examples. In some implementations, the user device may further indicate a type of account associated with the set of structured data (e.g., a depository account or a credit account, captured in an account type parameter). Therefore, the remote server may determine whether to include some categories, as described below, based on the type of account (e.g., not using “wages” as a category for a credit account).

In some implementations, the user device may perform a call to an API associated with a/transactions/enhance endpoint. In some implementations, the user device may include a set of credentials associated with the user device, such as an identifier and a secret and/or another type of access credentials. For example, the user device may include a client_id parameter that identifies the user device and a secret parameter that functions as a password associated with the user device and that authorizes the user device to request the remote server to enrich data (e.g., provided by the user device). The secret may have been generated by the remote server and provided to the user device to use in API calls. The secret may include a signature based on a private key associated with (e.g., via a key distribution center (KDC)) the user device. Although the example 100 is described with the user device including the set of credentials with the set of structured data, other examples may include the user device authenticating with the remote server before transmitting the set of structured data to the remote server.

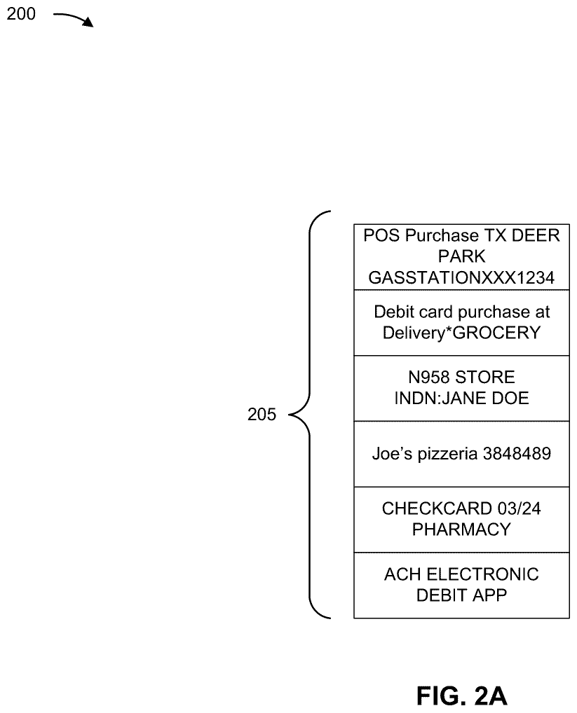

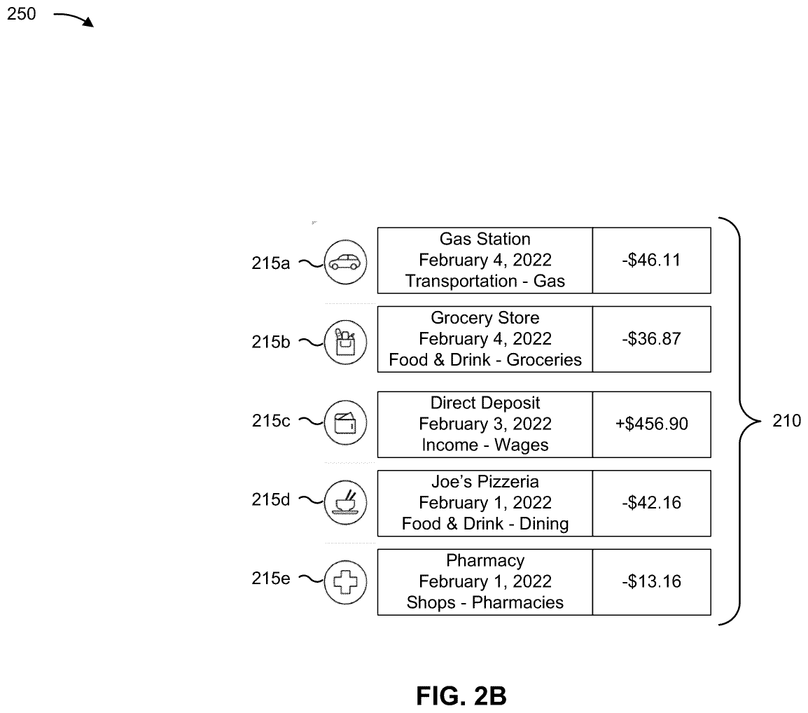

As shown in FIG. 1B by reference number 115, the remote server may parse the set of structured data to obtain a partial string for each event. For example, each event may be associated with a corresponding description string (e.g., as shown in FIG. 2A) such that the remote server extracts the partial string for each event from the corresponding description string. In some implementations, the remote server may extract multiple candidate strings (e.g., partial strings) rather than a single candidate string. For example, the remote server may extract a plurality of words from the corresponding description string (e.g., using spaces or other delimiters included in the corresponding description string) and generate a normalized plurality of words from the plurality of words. The normalization may include removal of symbols (e.g., ampersands, pound symbols, commas, or semicolons, among other examples). Additionally, the remote server may tokenize the normalized plurality of words to generate a plurality of word tokens. For example, the tokenization may separate numbers from letters even when there is no delimiter (e.g., separating “wm1234” into “wm” and “1234”). In another example, the tokenization may separate state codes, country codes, street names, and similar patterns even when there is no delimiter (e.g., separating “bostonma” into “boston” and “ma”). Therefore, the candidate strings may be the plurality of word tokens. Additionally, or alternatively, the plurality of word tokens may be recombined (with new delimiters) into a single candidate string.

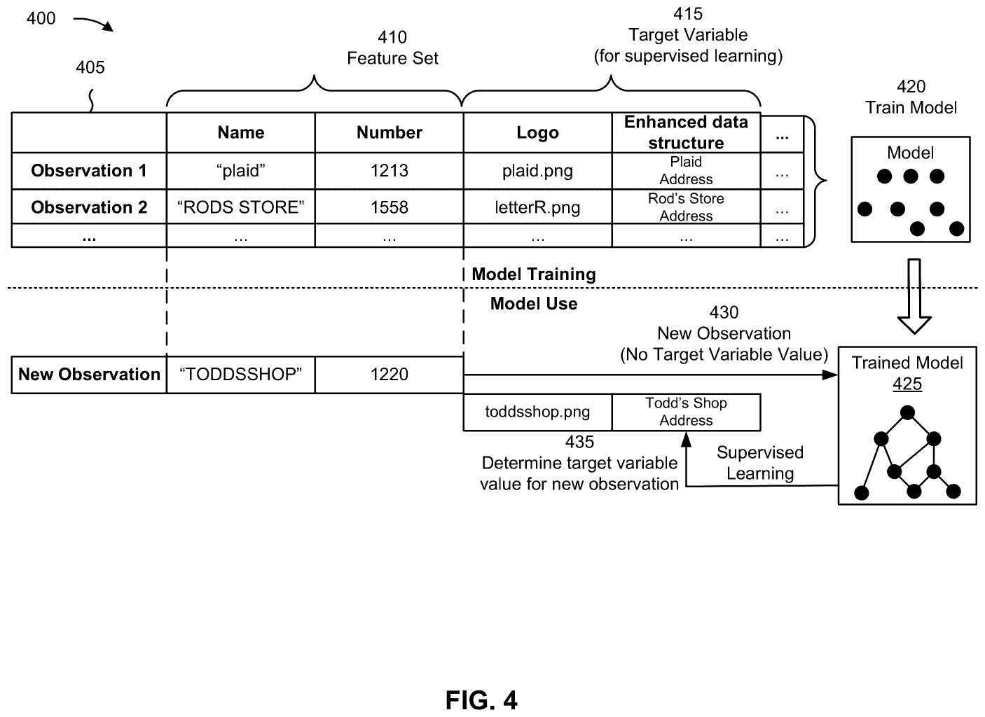

The remote server may apply one or more rules (e.g., regular expressions, also called “regexes”) to each description string to obtain the candidate string(s) for the corresponding event. For example, the remote server may extract one or more initial words, a numerical identifier (e.g., a store number or a location number, among other examples), a partial string from a beginning of the description string to a first non-alphabet character, a partial string matching a pattern corresponding to a merchant name (e.g., an alphabetic partial string excluding words or phrases like “POS,” “TST,” “ACH,” “transaction,” “purchase,” “withdrawal,” “debit card,” or “credit card,” among other examples). Additionally, or alternatively, the remote server may apply a machine learning model (e.g., as described in connection with FIG. 4) to extract the candidate string(s) for each corresponding event.

As shown by reference number 120, the remote server may use the candidate string(s) as one or more candidate queries to the database. The database may be implemented locally on the remote server or may be accessed via a network (e.g., a local network or the Internet, among other examples). For example, the remote server may perform a fuzzy search of names within the database in order to identify one or more candidate results. The fuzzy search may be based on a quantity of matching characters satisfying a threshold, a proportion of matching characters satisfying a threshold, and/or an application of known aliases (e.g., matching “name.com” with “name” or matching “nameN68th” with “nameNorth68th,” among other examples). Additionally, or alternatively, the remote server may apply a machine learning model (e.g., as described in connection with FIG. 4) to identify the candidate result(s) for each entry based on the candidate string(s).

Accordingly, as shown by reference number 125, the remote server may obtain the candidate result(s) from the database. For example, the database may return the candidate results as responses to the queries from the remote server. The candidate result(s) for each entry may be one or more data structures, each including at least a standardized name and a location indicator. The location indicator may be in a standardized format. In one example, the location indicator may include an address parameter, a city parameter, a region parameter, and/or a country parameter. In another example, the location indicator may include a lat parameter and a Ion parameter (thus using coordinates in lieu of, or in addition to, an address). Additionally, or alternatively, the location indicator may include a store_number parameter.

Additionally, or alternatively, the database may return corresponding categories, corresponding uniform resource locators (URLs), and/or corresponding images for the entries. The corresponding images may include logos, category images, and/or capital letters. Additionally, or alternatively, the remote server may identify a counterparty associated with at least one entry (e.g., the entry includes a mobile app name, a credit card name, or another processing party or third party) and may use the database to obtain a standardized name for the counterparty. In some implementations, the database may additionally return a corresponding image for the counterparty.

In some implementations, the remote server may additionally apply a machine learning model to one or more entries in the set of structured data, as shown in FIG. 1C by reference number 130. For example, the machine learning model may generate a standardized name, a location indicator, a corresponding URL, and/or a corresponding image when missing from the database. Accordingly, the remote server may apply the machine learning model when the candidate string(s) for an entry fail to produce any candidate results. The remote server may receive the output from the machine learning model, as shown by reference number 135, to supplement the candidate result(s). Alternatively, the remote server may use the machine learning model to identify a category for each entry in order to supplement the data structures included in the candidate results.

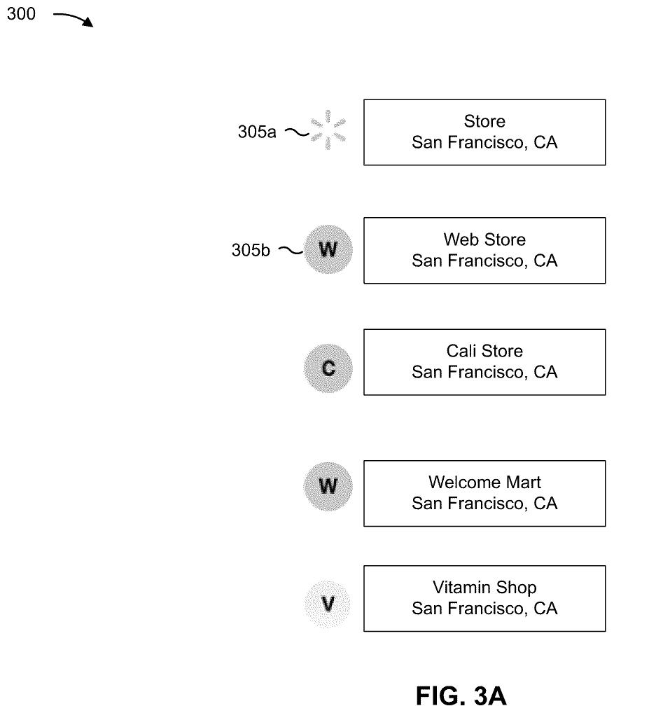

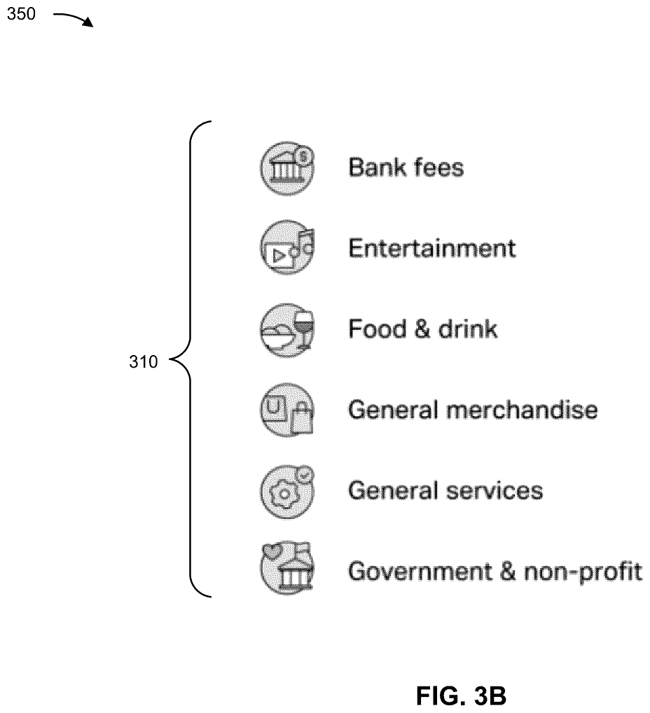

As shown in FIG. 1D by reference number 140, the remote server may generate new strings for the set of structured data. For example, the new strings may be standardized names extracted from the candidate results. Using the new strings, the remote server may lookup corresponding images for the set of structured data, as shown by reference number 145. Accordingly, the remote server may receive the corresponding images from the database, as shown by reference number 150. The corresponding images may be logos, capital letter images, and/or category images, as described in connection with FIGS. 3A and 3B.

In some implementations, the database with images may be the same as the database with the candidate result(s). Accordingly, the operations shown by reference number 145 and 150 may be the same operations shown by reference numbers 130 and 135.

Accordingly, as shown in FIG. 1E by reference number 155, the remote server may provide the standardized names and the corresponding images to the user device. In some implementations, the remote server may additionally provide location indicators and/or categories to the user device. For example, the remote server may return the names, images, location indicators, and/or categories in response to the API call described above. In some implementations, the remote server may additionally determine a date associated with each entry and return the dates in response to the API call.

In some implementations, the remote server may transmit the standardized name in a merchant_name parameter and the location indicator in a location parameter. Additionally, in some implementations, the remote server may transmit counterparty information (e.g., a counterparty name and optionally a counterparty image) in a counterparty object. The remote server may additionally indicate the categories using category, category_id, and/or personal_finance_category parameters. Additionally, information obtained from partial strings may include an identifier associated with an entry (e.g., included in a check_number parameter) and/or a type of location associated with an entry (e.g., an indication of in store, online, or other in a payment_channel parameter). In some implementations, the remote server may additionally or alternatively generate an alphanumeric identifier for each entry (e.g., in an entity_id parameter).

In some implementations, the remote server may additionally determine whether at least one entry is recurring. For example, the remote server may apply one or more rules to detect patterns in the set of structured data (e.g., entries that, with a proportion of matching characters that satisfy a match threshold, recur with a relatively regular frequency, such as within one or two days, or another margin of error, or of a monthly or semi-monthly schedule). Additionally, or alternatively, the remote server may apply a machine learning model (e.g., as described in connection with FIG. 4) to estimate whether an entry is recurring. The remote server may indicate whether the entry is recurring using an is_recurring parameter (e.g., a Boolean or another type of binary indicator).

In some implementations, as shown by reference number 160, the user device may provide feedback. For example, the feedback may include a ranking of the name, image, location indicator, and/or category associated with an entry, an indication (e.g., a Boolean) of whether the name associated with the entry is correct, an indication (e.g., a Boolean) of whether the category associated with the entry is correct, an indication (e.g., a Boolean) of whether the image associated with the entry is correct, and/or an indication (e.g., a Boolean) of whether the location indicator associated with the entry is correct, among other examples. Accordingly, as shown by reference number 165, the remote server may update the database and/or the machine learning model based on the feedback. For example, the remote server may update entries in the database with better names, categories, images, and/or location indicators. Additionally, or alternatively, the remote server may re-train the machine learning model based on the feedback.

As indicated above, FIGS. 1A-1E are provided as an example. Other examples may differ from what is described with regard to FIGS. 1A-1E.

FIGS. 2A and 2B are diagrams of example graphical user interfaces (GUIs) 200 and 250, respectively, associated with data enrichment. GUI 200 displays a set of structured data 205 (e.g., in a sequential order by date and/or transaction identifier). As shown in FIG. 2A, each event is associated with a description string that is machine-friendly rather than user-friendly.

As shown in FIG. 2B, GUI 250 displays a set of enhanced data structures 210 corresponding to the set of structured data (e.g., in a sequential order by date and/or transaction identifier). Each event may be associated with a standardized name, a standardized date, and an assigned category. Additionally, as shown in FIG. 2B, each event may be associated with an amount. In some implementations, each event may also be associated with a location indicator (e.g., an address, a city, and/or a set of coordinates) that may be displayed textually and/or visually (e.g., using a miniature map). As further shown in FIG. 2B, each event may be associated with a corresponding image (e.g., shown as images 215a, 215b, 215c, 215d, and 215e). As described in connection with FIGS. 3A-3B, the corresponding images may be logos, capital letters, and/or category images.

As indicated above, FIGS. 2A-2B are provided as examples. Other examples may differ from what is described with regard to FIGS. 2A-2B.

FIGS. 3A and 3B are diagrams of example GUIs 300 and 350, respectively, associated with images for data enrichment. GUI 300 displays a set of images corresponding to a set of structured data (e.g., in a sequential order by date and/or transaction identifier). As shown in FIG. 3A, each image comprises a logo for the event (e.g., image 305a in FIG. 3A) or a capital letter image corresponding to a first letter of a standardized name for the event (e.g., image 305b in FIG. 3A). Additionally, or alternatively, as shown in FIG. 3B by GUI 350, each image may comprise a logo corresponding to a category assigned to the event (e.g., shown as a set of category images 310 in FIG. 3B).

As indicated above, FIGS. 3A-3B are provided as examples. Other examples may differ from what is described with regard to FIGS. 3A-3B.

FIG. 4 is a diagram illustrating an example 400 of training and using a machine learning model in connection with data enrichment using name, location, and image lookup. The machine learning model training and usage described herein may be performed using a machine learning system. The machine learning system may include or may be included in a computing device, a server, a cloud computing environment, or the like, such as the user device described in more detail elsewhere herein.

As shown by reference number 405, a machine learning model may be trained using a set of observations. The set of observations may be obtained from training data (e.g., historical data), such as data gathered during one or more processes described herein. In some implementations, the machine learning system may receive the set of observations (e.g., as input) from a user device, as described elsewhere herein.

As shown by reference number 410, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the user device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a name, a second feature of a number, and so on. As shown, for a first observation, the first feature may have a value of “plaid”, the second feature may have a value of 1213, and so on. These features and feature values are provided as examples, and may differ in other examples. For example, the feature set may include one or more of the following features: other candidate strings (e.g., names or partial names) or candidate locations, among other examples.

As shown by reference number 415, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 400, the first target variable is a logo, which has a value of plaid.png for the first observation, and the second target variable for the first observation is an enhanced data structure that includes a standardized name of “Plaid” and a location indicator of an address.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 420, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 425 to be used to analyze new observations.

As shown by reference number 430, the machine learning system may apply the trained machine learning model 425 to a new observation, such as by receiving a new observation and inputting the new observation to the trained machine learning model 425. As shown, the new observation may include a first feature of “TODDSSHOP”, a second feature of 1220, and so on, as an example. The machine learning system may apply the trained machine learning model 425 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 425 may predict a value of toddsshop.png for the first target variable of logo and an enhanced data structure, for the second target variable for the new observation, that includes a standardized name of “Todd's Shop” a location indicator of an address, as shown by reference number 435. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, using the logo and/or the enhanced data structure in a GUI. The first automated action may include, for example, transmitting the logo and/or the enhanced data structure to the user device.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations and actions described above are provided as examples, and other examples may differ from what is described above.

In some implementations, the trained machine learning model 425 may be re-trained using feedback information. For example, feedback may be provided to the machine learning model. The feedback may be associated with actions performed based on the recommendations provided by the trained machine learning model 425 and/or automated actions performed, or caused, by the trained machine learning model 425. In other words, the recommendations and/or actions output by the trained machine learning model 425 may be used as inputs to re-train the machine learning model (e.g., a feedback loop may be used to train and/or update the machine learning model). For example, the feedback information may include a user ranking of the logo and/or the enhanced data structure, an indication (e.g., a Boolean) of whether the standardized name is correct, and/or an indication (e.g., a Boolean) of whether the location indicator is correct, among other examples.

In this way, the machine learning system may apply a rigorous and automated process to matching partial strings to logos and data structures. The machine learning system enables recognition and/or identification of tens, hundreds, thousands, or millions of features and/or feature values for tens, hundreds, thousands, or millions of observations, thereby increasing accuracy and consistency and reducing delay associated with matching relative to requiring computing resources to be allocated for tens, hundreds, or thousands of operators to manually match partial strings to logos and data structures using the features or feature values.

As indicated above, FIG. 4 is provided as an example. Other examples may differ from what is described in connection with FIG. 4.

FIG. 5 is a diagram of an example environment 500 in which systems and/or methods described herein may be implemented. As shown in FIG. 5, environment 500 may include a remote server 501, which may include one or more elements of and/or may execute within a cloud computing system 502. The cloud computing system 502 may include one or more elements 503-512, as described in more detail below. As further shown in FIG. 5, environment 500 may include a network 520, a user device 530, a database 540, and/or a machine learning (ML) model 550. Devices and/or elements of environment 500 may interconnect via wired connections and/or wireless connections.

The cloud computing system 502 includes computing hardware 503, a resource management component 504, a host operating system (OS) 505, and/or one or more virtual computing systems 506. The cloud computing system 502 may execute on, for example, an Amazon Web Services platform, a Microsoft Azure platform, or a Snowflake platform. The resource management component 504 may perform virtualization (e.g., abstraction) of computing hardware 503 to create the one or more virtual computing systems 506. Using virtualization, the resource management component 504 enables a single computing device (e.g., a computer or a server) to operate like multiple computing devices, such as by creating multiple isolated virtual computing systems 506 from computing hardware 503 of the single computing device. In this way, computing hardware 503 can operate more efficiently, with lower power consumption, higher reliability, higher availability, higher utilization, greater flexibility, and lower cost than using separate computing devices.

Computing hardware 503 includes hardware and corresponding resources from one or more computing devices. For example, computing hardware 503 may include hardware from a single computing device (e.g., a single server) or from multiple computing devices (e.g., multiple servers), such as multiple computing devices in one or more data centers. As shown, computing hardware 503 may include one or more processors 507, one or more memories 508, and/or one or more networking components 509. Examples of a processor, a memory, and a networking component (e.g., a communication component) are described elsewhere herein.

The resource management component 504 includes a virtualization application (e.g., executing on hardware, such as computing hardware 503) capable of virtualizing computing hardware 503 to start, stop, and/or manage one or more virtual computing systems 506. For example, the resource management component 504 may include a hypervisor (e.g., a bare-metal or Type 1 hypervisor, a hosted or Type 2 hypervisor, or another type of hypervisor) or a virtual machine monitor, such as when the virtual computing systems 506 are virtual machines 510. Additionally, or alternatively, the resource management component 504 may include a container manager, such as when the virtual computing systems 506 are containers 511. In some implementations, the resource management component 504 executes within and/or in coordination with a host operating system 505.

A virtual computing system 506 includes a virtual environment that enables cloud-based execution of operations and/or processes described herein using computing hardware 503. As shown, a virtual computing system 506 may include a virtual machine 510, a container 511, or a hybrid environment 512 that includes a virtual machine and a container, among other examples. A virtual computing system 506 may execute one or more applications using a file system that includes binary files, software libraries, and/or other resources required to execute applications on a guest operating system (e.g., within the virtual computing system 506) or the host operating system 505.

Although the remote server 501 may include one or more elements 503-512 of the cloud computing system 502, may execute within the cloud computing system 502, and/or may be hosted within the cloud computing system 502, in some implementations, the remote server 501 may not be cloud-based (e.g., may be implemented outside of a cloud computing system) or may be partially cloud-based. For example, the remote server 501 may include one or more devices that are not part of the cloud computing system 502, such as device 600 of FIG. 6, which may include a standalone server or another type of computing device. The remote server 501 may perform one or more operations and/or processes described in more detail elsewhere herein.

Network 520 includes one or more wired and/or wireless networks. For example, network 520 may include a cellular network, a public land mobile network (PLMN), a local area network (LAN), a wide area network (WAN), a private network, the Internet, and/or a combination of these or other types of networks. The network 520 enables communication among the devices of environment 500.

The user device 530 includes one or more devices capable of receiving, generating, storing, processing, and/or providing information associated with data enrichment, as described elsewhere herein. The user device 530 may include a communication device and/or a computing device. For example, the user device 530 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The database 540 may be implemented on one or more devices capable of receiving, generating, storing, processing, and/or providing information associated with data enrichment, as described elsewhere herein. The database 540 may be implemented on a communication device and/or a computing device. For example, the database 540 may be implemented on a server, a database server, an application server, a client server, a web server, a host server, a proxy server, a virtual server (e.g., executing on computing hardware), a server in a cloud computing system, a device that includes computing hardware used in a cloud computing environment, or a similar type of device. The database 540 may communicate with one or more other devices of environment 500, as described elsewhere herein.

The ML model 550 may be implemented on one or more devices capable of receiving, generating, storing, processing, and/or providing information associated with data enrichment, as described elsewhere herein. The ML model 550 may be implemented on a communication device and/or a computing device. For example, the ML model 550 may be implemented on a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML model 550 may communicate with one or more other devices of environment 500, as described elsewhere herein.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600, which may correspond to a user device, a remote server, a device implementing a database, and/or a device implementing an ML model. In some implementations, the user device, the remote server, the device implementing the database, and/or the device implementing the ML model may include one or more devices 600 and/or one or more components of device 600. As shown in FIG. 6, device 600 may include a bus 610, a processor 620, a memory 630, an input component 640, an output component 650, and a communication component 660.

Bus 610 includes one or more components that enable wired and/or wireless communication among the components of device 600. Bus 610 may couple together two or more components of FIG. 6, such as via operative coupling, communicative coupling, electronic coupling, and/or electric coupling. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform one or more operations or processes described elsewhere herein.

Memory 630 includes volatile and/or nonvolatile memory. For example, memory 630 may include random access memory (RAM), read only memory (ROM), a hard disk drive, and/or another type of memory (e.g., a flash memory, a magnetic memory, and/or an optical memory). Memory 630 may include internal memory (e.g., RAM, ROM, or a hard disk drive) and/or removable memory (e.g., removable via a universal serial bus connection). Memory 630 may be a non-transitory computer-readable medium. Memory 630 stores information, instructions, and/or software (e.g., one or more software applications) related to the operation of device 600. In some implementations, memory 630 includes one or more memories that are coupled to one or more processors (e.g., processor 620), such as via bus 610.

Input component 640 enables device 600 to receive input, such as user input and/or sensed input. For example, input component 640 may include a touch screen, a keyboard, a keypad, a mouse, a button, a microphone, a switch, a sensor, a global positioning system sensor, an accelerometer, a gyroscope, and/or an actuator. Output component 650 enables device 600 to provide output, such as via a display, a speaker, and/or a light-emitting diode. Communication component 660 enables device 600 to communicate with other devices via a wired connection and/or a wireless connection. For example, communication component 660 may include a receiver, a transmitter, a transceiver, a modem, a network interface card, and/or an antenna.

Device 600 may perform one or more operations or processes described herein. For example, a non-transitory computer-readable medium (e.g., memory 630) may store a set of instructions (e.g., one or more instructions or code) for execution by processor 620. Processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry is used instead of or in combination with the instructions to perform one or more operations or processes described herein. Additionally, or alternatively, processor 620 may be configured to perform one or more operations or processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

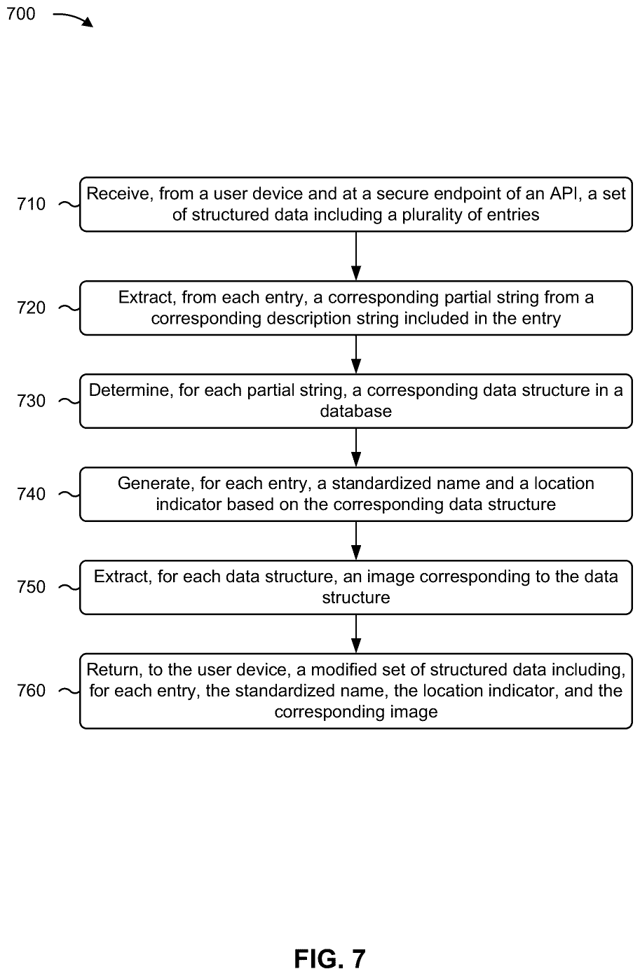

FIG. 7 is a flowchart of an example process 700 associated with data enrichment using name, location, and image lookup. In some implementations, one or more process blocks of FIG. 7 may be performed by the remote server 501. In some implementations, one or more process blocks of FIG. 7 may be performed by another device or a group of devices separate from or including the remote server 501, such as the user device 530, the database 540, and/or the ML model 550. Additionally, or alternatively, one or more process blocks of FIG. 7 may be performed by one or more components of the device 600, such as processor 620, memory 630, input component 640, output component 650, and/or communication component 660.

As shown in FIG. 7, process 700 may include receiving, from a user device and at a secure endpoint of an API, a set of structured data including a plurality of entries (block 710). As further shown in FIG. 7, process 700 may include extracting, from each entry, a corresponding partial string from a corresponding description string included in the entry (block 720).

Additionally, as shown in FIG. 7, process 700 may include determining, for each partial string, a corresponding data structure in a database (block 730). As further shown in FIG. 7, process 700 may include generating, for each entry, a standardized name and a location indicator based on the corresponding data structure (block 740).

As further shown in FIG. 7, process 700 may include extracting, for each data structure, an image corresponding to the data structure (block 750). Accordingly, as shown in FIG. 7, process 700 may include returning, to the user device, a modified set of structured data including, for each entry, the standardized name, the location indicator, and the corresponding image (block 760).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1E, 2A-2B, 3A-3B, and/or 4.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data enrichment, the system comprising:
one or more memories; and
one or more processors, communicatively coupled to the one or more memories, configured to:
receive, from a user device and at a secure endpoint of an application programming interface (API), a set of structured data including a plurality of entries;
extract, from each entry, a corresponding partial string from a corresponding description string included in the entry;
determine, using a fuzzy search for each partial string, a corresponding data structure in a database;
generate, for each entry, a standardized name and a location indicator based on the corresponding data structure;
determine, for each entry, a corresponding image using the standardized name and an image database; and
return, to the user device, a modified set of structured data including, for each entry, the standardized name, the location indicator, and the corresponding image.

2. The system of claim 1, wherein each partial string comprises a name or a numerical identifier.

3. The system of claim 1, wherein each data structure includes at least the standardized and the location indicator.

4. The system of claim 1, wherein the one or more processors, to extract the corresponding partial string, are configured to:
apply a machine learning model to parse the entries.

5. The system of claim 1, wherein each image comprises a logo, a capital letter image, or a category image.

6. The system of claim 1, wherein the one or more processors are configured to:
generate, for at least one of the entries, a counterparty based on the corresponding partial string,
wherein the modified set of structured data further includes a name associated with the counterparty.

7. The system of claim 6, wherein the one or more processors are configured to:
determine, for the counterparty, a corresponding image using the name of the counterparty and the image database,
wherein the modified set of structured data further includes the corresponding image for the counterparty.

8. A method of data enrichment, comprising:
receiving, from a user device and at a secure endpoint of an application programming interface (API), a set of structured data including a plurality of entries;
extracting, from each entry, a corresponding partial string from a corresponding description string included in the entry;
determining, for each partial string, a corresponding data structure in a database;
generating, for each entry, a standardized name and a location indicator based on the corresponding data structure;
extracting, for each data structure, an image corresponding to the data structure; and
returning, to the user device, a modified set of structured data including, for each entry, the standardized name, the location indicator, and the corresponding image.

9. The method of claim 8, wherein the location indicator comprises an address, a city name, a set of coordinates, or a combination thereof.

10. The method of claim 8, wherein extracting the corresponding partial string comprises:
extracting a plurality of words from the corresponding description string; and
generating a normalized plurality of words from the plurality of words,
wherein the corresponding partial string is based on the normalized plurality of words.

11. The method of claim 10, wherein extracting the corresponding partial string further comprises:
tokenizing the normalized plurality of words to generate a plurality of word tokens,
wherein the corresponding partial string is based on the plurality of word tokens.

12. The method of claim 8, further comprising:
estimating whether at least one entry in the plurality of entries is recurring,
wherein the modified set of structured data further includes an indication of whether the at least one entry is recurring.

13. The method of claim 8, further comprising:
determining, for each partial string, a corresponding date,
wherein the modified set of structured data further includes, for each entry, the corresponding date.

14. The method of claim 8, further comprising:
extracting, for each data structure, a uniform resource location (URL) corresponding to the data structure,
wherein the modified set of structured data further includes, for each entry, the corresponding URL.

15. A non-transitory computer-readable medium storing a set of instructions for data enrichment, the set of instructions comprising:
one or more instructions that, when executed by one or more processors of a device, cause the device to:
receive, from a user device and at a secure endpoint of an application programming interface (API), a set of structured data including a plurality of entries;
extract, from each entry, one or more candidate strings from a corresponding description string included in the entry;
determine, for each entry, one or more candidate data structures in a database mapping to the one or more candidate strings;
generate, for each entry, a standardized name and a location indicator based on a selected data structure from the one or more candidate data structures; and
return, to the user device, a modified set of structured data including, for each entry, the standardized name and the location indicator.

16. The non-transitory computer-readable medium of claim 15, wherein the one or more instructions that, cause the device to extract the one or more candidate strings, are executed by the one or more processors to cause the device to:
apply one or more rules to the corresponding description string.

17. The non-transitory computer-readable medium of claim 15, wherein the one or more instructions that, cause the device to determine the one or more candidate data structures, are executed by the one or more processors to cause the device to:
apply a machine learning model to map the one or more candidate strings to the one or more candidate data structures.

18. The non-transitory computer-readable medium of claim 15, wherein the one or more instructions, when executed, cause the device to:
determine, for each entry, a corresponding category,
wherein the modified set of structured data further includes, for each entry, the corresponding category.

19. The non-transitory computer-readable medium of claim 15, wherein the one or more instructions, when executed, cause the device to:
authenticate the user device based on a secret received with the set of structured data,
wherein the modified set of structured data is returned based on authenticating the user device.

20. The non-transitory computer-readable medium of claim 15, wherein the location indicator is associated with a standardized format.
